(19) United States
(12) Patent Application Publication
(10) Pub. No.: US 2025/0218070 A1
(43) Pub. Date: Jul. 3, 2025

(54) Art Inspiration, Creation, and Distribution Platform

(71) Applicants: Aidan Connor Shoemaker, Seattle, WA (US); Ethan Edward Huey, Sammamish, WA (US)

(72) Inventors: Aidan Connor Shoemaker, Seattle, WA (US); Ethan Edward Huey, Sammamish, WA (US)

(21) Appl. No.: 19/004,321

(22) Filed: Dec. 28, 2024

Related U.S. Application Data
(60) Provisional application No. 63/616,581, filed on Dec. 30, 2023.

(51) Int. Cl. G06T 11/20; G06F 3/0482; G06V 10/764; G06V 10/82

(52) U.S. Cl. CPC G06T 11/203; G06F 3/0482; G06V 10/764; G06V 10/82

(57) ABSTRACT

Systems, devices, and methods are described for providing, among other things, a digital art interface including electrical circuitry configured to receive user-generated digital art content; extract art element data from the user-generated digital art content; determine prompt data based on the extracted art element data. Also described are systems, devices, and methods including electrical circuitry configured to broadcast a prompt request over a communications network to digital content providers, distributed network of client devices, peer groups, prompt providers, specific artist groups, unique prompt data providers, user selected content providers, and the like.

### RELATED APPLICATIONS

This application claims the benefit of priority under 35 USC § 119(e) of U.S. Provisional Patent Application No. 63/616,581, filed Dec. 30, 2023, the contents of which are incorporated herein by reference in their entirety.

### SUMMARY

In an aspect, the present disclosure is directed to, among other things, a digital art system including a digital art interface including electrical circuitry configured to receive user-generated digital art content and to extract art element data from the user-generated digital art content; and a prompt determination component including electrical circuitry configured to determine prompt data based on the extracted art element data. In an embodiment, the digital art system includes one or more instances of a selectable menu that allows users to view the user-generated digital art content. In an embodiment, the digital art system includes a prompt broadcast interface including electrical circuitry configured to broadcast a prompt request based on receiving the user-generated digital art content.

In an aspect, the present disclosure is directed to, among other things, a system including a digital art interface configured to receive user-generated digital art content and to extract art element data from the user-generated digital art content; a prompt determination component configured to determine prompt data based on the extracted art element data; and a prompt broadcast interface configured to broadcast a prompt request based on receiving the user-generated digital art content. In an embodiment, the system includes an intellectual property rights component configured to enable a blockchain smart contract process that implement a creative work license event associated with the user-generated digital art content or the prompt data. In an embodiment, the system includes a prompt output interface configured to generate one or more instances of a selectable menu that allows users to view the user-generated digital art content.

In an aspect, the present disclosure is directed to, among other things, a digital art prompt system including means for receiving user-generated digital art content and extracting art element data from the user-generated digital art content; means for determining prompt data based on the extracted art element data; means for broadcasting a prompt request based on receiving the user-generated digital art content; means for exchanging prompt data between a plurality of users; and means for implementing a creative work license event associated with the user-generated digital art content or the prompt data.

In an aspect, the present disclosure is directed to, among other things, a method, including extracting art element data associated with user-generated digital art content; and determining prompt data responsive to extracting the art element data. In an embodiment, the method includes receiving user-generated digital art content in the form of one or more digital images. In an embodiment, the method includes broadcasting a prompt request based on the determining prompt data. In an embodiment, the method includes receiving user-generated digital art content in the form of one or more digital images. In an embodiment, the method includes exchanging prompt data between a plurality of users. In an embodiment, the method includes implementing a creative work license event associated with the exchanging prompt data. In an embodiment, the method includes exchanging participant generated prompt data between a plurality of users.

### BRIEF DESCRIPTION OF THE FIGURES

FIG. 1 is a schematic diagram of a digital art system according to an embodiment.

FIG. 2 is a schematic diagram of a digital art system according to an embodiment.

FIG. 3 is a schematic diagram of a digital art system according to an embodiment.

FIG. 4 is a schematic diagram of an onboarding and user setup process.

FIGS. 5&6 shows a user experience flow process for a digital art prompt system according to an embodiment.

FIG. 7 shows an Application High Level Overview flow process for a digital art prompt system according to an embodiment.

FIG. 8 shows Prompt Generation High Level Overview flow process for a digital art system according to an embodiment.

FIG. 9 shows a flow diagram of a method according to an embodiment.

FIG. 10 shows an AI-powered platform interface (SPARKSKETCH™) implemented in computational circuitry according to an embodiment.

FIG. 11 shows an AI-powered platform interface implemented in computational circuitry according to an embodiment.

FIG. 12 shows an AI-powered platform interface implemented in computational circuitry according to an embodiment.

### DETAILED DESCRIPTION

Creativity is vital to our well-being. It drives progress by nurturing the ability to consider alternative ways to solve problems, create community, and negotiate life in an ever-changing environment. Creativity is a fundamental component of our social and cultural identity. One way to engender a culture of creativity is by providing technological platforms that engage users in the artistic process and the process of creating art. Accordingly, the present disclosure is directed to providing users, content creators, artist, and the like, with the tools, processes, and technologies that foster creativity and art creation by cultivating digital art inspiration communities.

Although art creation software is plentiful, it often requires a user to possess an advanced technical skill set and a competency that spans multiple digital drawing and illustration platforms. Typical drawing platforms often cater to highly skilled digital illustrators and artists who are highly motivated to develop their skills through self-managed advanced training. But these drawing platforms often lack features and functionality directed to providing access and engaging casual users. Accordingly, in an embodiment, the disclosed technologies and methodologies are directed to a digital art prompt system configured to detect indicators of artist skill proficiency and to generate prompt data responsive to one or more inputs indicative of artist skill proficiency level.

Collaboration strengthen communities. Accordingly, in an embodiment, the disclosed technologies and methodologies are directed to fostering community by enabling users to engage via a social media engagement platform and exchange art content. By introducing the ability to share and comment on the art of others, drawing not only becomes an exercise of creativity, but one of socialization as well. In current art software, the creation of art and the sharing art are separate processes. One must create in one platform and share via a different platform, thus making the process of sharing one's art more complicated than necessary. With creation and sharing bundled together, distributing one's art to friends, family, or the global community becomes much more straightforward. People are enabled to both engage in the creative aspect of online artistry or simply engage in the community aspect of sharing and commenting on art.

Likewise, the ability for users to view prompts tailored to their own skill level, and to the style of art they are most interested in gives incentive for potential artists to continue learning. Creative burnout causes many aspiring artists to give up early on, but with the use of daily prompts, inspiration will never run dry. No matter the artist's level of expertise, this invention would serve to educate them and motivate them to learn and develop. The prompts themselves are also essential to the development of artists. Given a blank canvas, many artists struggle to come up with an idea to start their drawing. Prompts will give these artists the inspiration they need to get started on their drawing without restricting their process. Prompts can additionally carry information that will assist artists in developing their skills in a specific medium. By including a different task or new technique in each prompt, artists will be able to slowly become more proficient in their areas of study. With shareable drawing prompts, creators will be more motivated, more connected, and more educated, allowing more prospective artists to progress and succeed.

### Digital Art Interface

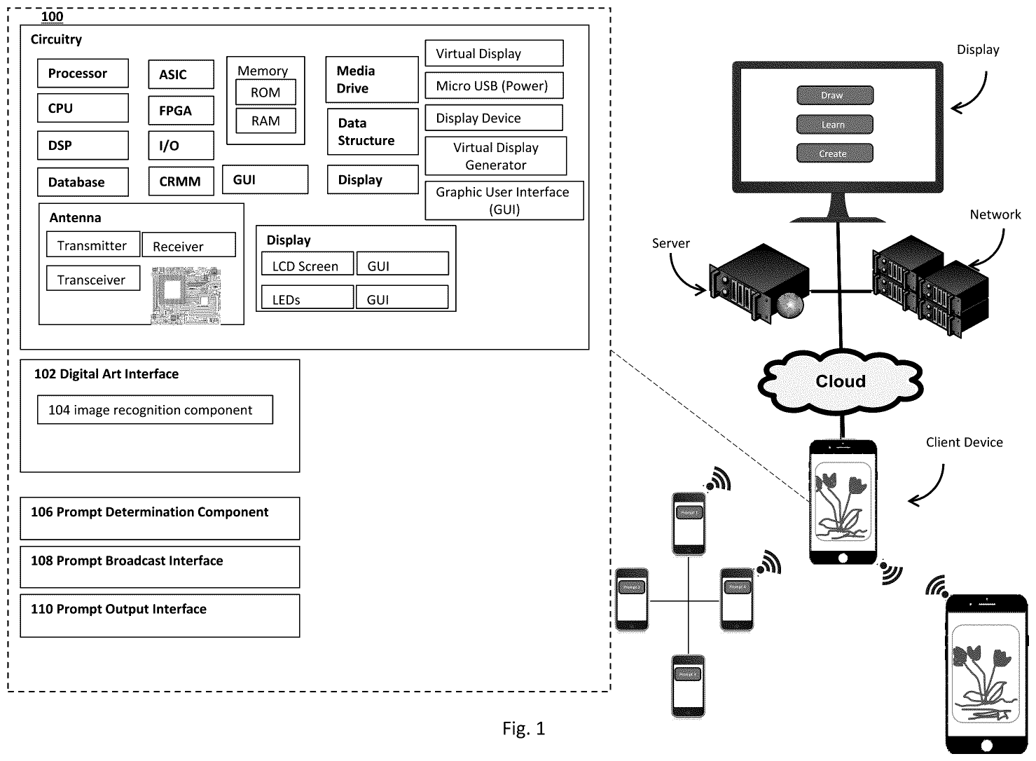

FIG. 1 shows a digital art system 100 in which one or more of the disclosed methodologies or technologies can be implemented. In an embodiment, the digital art system 100 includes a digital art interface 102 including electrical circuitry configured to extract art element data from user-generated digital art content. Examples of art element data include, among other things, data indicative of balance (symmetry, asymmetry), Color (primary, secondary, mixed, complimentary, warm, cool, decorative, values), Emphasis and Subordination, Function/Setting (architecture), Interior/Exterior Relationship (architecture) Light and Value (source, flat, strong, contrasting, even, values, emphasis, shadows) Line (straight, curved, angular, flowing, horizontal, vertical, diagonal, contour, thick, thin, implied etc.), Mass/Volume (three-dimensional art), Principles of Design, Rhythm, Scale and Proportion (weight, how objects or figures relate to each other and the setting), Shape (what shapes are created and how), Space (depth, overlapping, kinds of perspective), Texture and Pattern (real, implied, repeating), Time and Motion, Unity and Variety, and the like.

In an embodiment, the digital art interface 102 includes an image recognition component 104 configured to extract art element data from the user-generated digital art content. In an embodiment, the digital art interface 102 includes an image recognition component 104 configured to classify the user-generated digital art content. In an embodiment, the digital art interface 102 includes an image recognition component 104 configured to detect objects within images associated with the user-generated digital art content.

In an embodiment, the digital art interface 102 includes an image recognition component 104 configured to categorize pixels in an image associated with the user-generated digital art content into an art element class or art an element object. In an embodiment, the image recognition component 104 includes one or more Artificial Neural Networks (ANN) trained to extract art element data. In an embodiment, the image recognition component 104 includes one or more Convolutional Neural Networks (CNN) trained to extract art element data. In an embodiment, the image recognition component 104 includes one or more Vision Transformers (ViT) using Natural Language Processing (NLP) trained to extract art element data.

In an embodiment, the digital art interface 102 includes computational circuitry configured to detect, identify, recognize, classify, or the like objects within images associated with the user-generated digital art content. In an embodiment, the digital art interface 102 includes an image recognition component 104 configured to detect, identify, recognize, classify, or the like objects within images associated with the user-generated digital art content. In an embodiment, the digital art interface 102 includes an image recognition component 104 configured to detect, identify, recognize, classify, or the like indicators of artist skill proficiency within images. In an embodiment, the digital art interface 102 includes an image recognition component trained to recognize artist skill proficiency indicators within the user-generated digital art content and to generate the prompt data responsive to one or more inputs indicative of artist skill proficiency level.

In an embodiment, the digital art interface 102 includes an image recognition component 104 configured to detect, identify, recognize, classify, or the like indicators of artist skill proficiency within images and to generate prompt data responsive to one or more inputs indicative of artist skill proficiency level. In an embodiment, the digital art interface 102 includes an image recognition component 104 configured to categorize pixels in an image associated with the user-generated digital art content using one or more semantic image segmentation techniques. In an embodiment, the digital art interface 102 further includes computational circuitry configured to generate a digital art prompt including at least one digital image and at least one natural language prompt responsive to one or more inputs indicative of user request to supply additional prompt associated with an initial request to generate a daily digital prompt.

In an embodiment, the digital art interface 102 includes an image recognition component 104 configured to categorize pixels in an image and to provide periodic digital art content and one or more natural language prompts based on a calculated prompt level. In an embodiment, the digital art interface 102 includes computational circuitry configured to generate digital art prompts and structured instruction configured to be interpreted and understood by a generative AI model based on a calculated prompt level.

In an embodiment, the digital art interface 102 includes an image recognition component 104 configured to detect, identify, recognize, classify, or the like indicators of artist skill proficiency indicators within images using a neural network trained to locate individual objects indicative of artist skill proficiency based directly on pixel data. In an embodiment, the digital art interface 102 includes an image recognition component 104 configured to detect, identify, recognize, classify, or the like indicators of artist skill proficiency indicators within images using a feature-based object recognition neural classifier.

In an embodiment, the digital art interface 102 includes an image recognition component 104 including a pixel classifier trained to recognize one or more of art media identification, art style, artist skill level, artist skill proficiency rating, artist skill proficiency level, drawing style, visual art technique or the like. In an embodiment, the digital art interface 102 includes computational circuitry configured to implement pixel-level analysis using one or more pixel-by-pixel analysis object recognition tools, such as, for example, Amazon Rekognition, ArcGIS Pro, Azure AI Vision, Clarifai, Google Cloud Vision API, Google Vision AI, Imagga, Labellerr, Lenso ai, OpenCV, or the like.

In an embodiment, the extracted art element data includes one or more parameters indicative of an art style. Examples of parameters indicative of an art style include, among other things, parameters indicative of the presence or absence of an art movement or art style. Examples of parameters indicative of an art style include, among others, parameters indicative of the presence or absence of Abstract Expressionism, Art Deco, Art Nouveau, Avant-garde, Baroque, Bauhaus, Classicism, CoBrA, Color Field Painting, Conceptual Art, Constructivism, Cubism, Dada/Dadaism, Digital Art, Expressionism, Fauvism, Futurism, Harlem Renaissance, Impressionism, Installation Art, Land Art, Minimalism, Neo-Impressionism, Neoclassicism, Neon Art, Op Art, Performance Art, Pop Art, Post-Impressionism, Precisionism, Rococo, Street Art, Surrealism, Suprematism, Symbolism, Zero Group, or the like.

In an embodiment, the digital art interface 102 is configured to extract one or more parameters indicative of art media. Examples of parameters indicative of art media include parameters indicative of materials, tools, pencil and paper, smart device and drawing software, tablet and stylus, touch device and appendage, and the like used by a user, artist, etc., to create a work of art.

In an embodiment, the digital art interface 102 is configured to extract one or more parameters indicative of a drawing style. Examples of parameters indicative of drawing style include parameters indicative of an Anamorphic drawing, Architectural drawing, Caricature drawing, Cartoon style, Cross-contour drawing, 3D drawing, Diagrammatic drawing, Doodling, Fashion illustration, Geometric drawing, Hatching and cross-hatching, Hyperrealism, Line drawing, Minimalist drawing, Photorealism, Quick sketches, Scribble art, Scumbling, Stippling, Tattoo drawing, Typography drawing, and the like.

In an embodiment, the digital art interface 102 is configured to determine a classification associated with the user-generated digital art content based on shapes, shape combinations, color combination, brush size, brush type, and the like. In an embodiment, the digital art system 100 includes a digital art interface 102 including electrical circuitry configured to receive user-generated digital art content. In an embodiment, the digital art interface 102 includes electrical circuitry configured to receive user-generated digital art content in the form of one or more digital images.

### Prompt Determination Component

In an embodiment, the digital art system 100 includes a prompt determination component 106 including electrical circuitry configured to determine prompt data. In an embodiment, the prompt determination component 106 includes electrical circuitry configured to determine prompt data based on the extracted art element data.

In an embodiment, the prompt determination component 106 is configured to determine the prompt data based on one or more inputs indicative of a social media trend. In an embodiment, the prompt determination component 106 is configured to determine the prompt data based on social media trend data. In an embodiment, the prompt determination component 106 is configured to determine the prompt data based on crowd-sourced data.

In an embodiment, the digital art interface 102 is configured to determine a classification associated with the user-generated digital art content; and the prompt determination component 106 is configured to determine the prompt data based on the classification associated with the user-generated digital art content. In an embodiment, prompt data includes drawing prompt data. Non-limiting examples of drawing prompt data include guidelines, descriptions, events, instructions, sounds, images, videos, digital content, project goals, metaverse content, digital mood boards, digital color palettes, etc. Further non-limiting examples of prompt data include retrospective prompts, contemplative prompts, introspective prompts, descriptive prompts, stylistic prompts, and the like. Further non-limiting examples of prompt data include one or more prompt text messages such as those found at theartchi.com/blogs/blog/boost-your-artistic-skills-the-ultimate-list-of-drawing-prompts-for-every-level and listed below.

“Draw a scene from your favorite book or movie: Choose a memorable scene and put your own spin on it.”

“Draw your ideal landscape: Add hills, trees, cities, or whatever you prefer.

“Illustrate a favorite quote: Choose an inspiring quote or a line from a piece of media and create a visual representation of its meaning.”

“Draw in a new style: Choose a previous drawing and recreate it in a new art style.”

“Illustrate an abstract concept: Choose a complex concept, such as love, time, or freedom, and create an abstract artwork that visually represents its essence.”

In an embodiment, the prompt determination component 106 is configured to generate classification data associated with the user-generated digital art content and to determine a prompt level based on the classification data. In an embodiment, the prompt determination component 106 is configured to determine a prompt uniqueness score. In an embodiment, the prompt determination component 106 is configured to determine a match score indicative a degree of closeness between the user-generated digital art content and the generated prompt data. In an embodiment, the prompt determination component 106 includes an artificial intelligence module trained to detect indicators of artist skill proficiency and to determine a user prompt ability profile based on the extracted art element data, and a correlation policy.

In an embodiment, the artificial intelligence module is trained to detect indicators of artist skill proficiency and to determine the user prompt ability profile. In an embodiment, the prompt determination component 106 is configured to generate prompt data responsive to one or more inputs indicative of a user-specific drawing history level. In an embodiment, the prompt determination component 106 is configured to generate prompt data and to transform the prompt data into a drawing instruction set. In an embodiment, the prompt determination component 106 configured to generate prompt data and to transform the prompt data into a drawing instruction set that is commensurate with a user ability index.

In an embodiment, the prompt determination component 106 is configured to generate prompt data and to transform the prompt data into a drawing instruction video. In an embodiment, the prompt determination component 106 is configured to generate user-specific prompt data designed and generated to educate users on drawing skills. In an embodiment, the prompt determination component 106 includes an artificial intelligence module trained to generate prompt data based on a user-specific drawing historical data. In an embodiment, the prompt determination component 106 includes an artificial intelligence module trained to generate prompt data based on tag art technique image sets. In an embodiment, the prompt determination component 106 is configured to generate prompts and to transform them into a drawing instruction set that focuses on a specific drawing skill. In an embodiment, the prompt determination component 106 is configured to generate prompts associated with a user-selected art type.

In an embodiment, the prompt determination component 106 is configured to generate prompts associated with a user-selected skill. In an embodiment, the prompt determination component 106 is configured to determine user-specific prompts by mapping user skill level. In an embodiment, the prompt determination component 106 is configured to periodically re-map a user's artist skill level and to generate prompt data responsive to the re-mapping. In an embodiment, the prompt determination component 106 is configured to generate prompt data responsive to one or more inputs indicative of user selected drawing or painting technique.

### Prompt Output Interface

In an embodiment, the digital art system 100 includes a prompt output interface 110. In an embodiment, the prompt output interface 110 is configured to generate one or more instances of a selectable menu that allows users to view the user-generated digital art content. In an embodiment, the prompt output interface 110 is configured to generate one or more virtual instances that allows a user to set access permissions associated with the user-generated digital art content. In an embodiment, the prompt output interface 110 is configured to display one or more virtual elements associated with the prompt data.

In an embodiment, the prompt output interface 110 is configured to display one or more virtual elements associated with the user-generated digital art content. In an embodiment, the prompt determination component 106 is configured to evaluate whether the determined match score meets or exceeds a threshold match score; and the prompt output interface 110 is configured to display one or more virtual elements associated with the prompt data responsive to whether the determined match score meets or exceeds the threshold match score.

### Prompt Broadcast Interface

In an embodiment, the digital art system 100 includes a prompt broadcast interface 108. In an embodiment, the prompt broadcast interface 108 includes electrical circuitry configured to broadcast a prompt request based on receiving the user-generated digital art content. In an embodiment, the prompt broadcast interface 108 includes a plurality of processor-based user devices configured to transmit prompt data requests over a communications network. In an embodiment, each processor-based user device is associated with a unique prompt data provider. In an embodiment, the prompt broadcast interface 108 is configured to transmit prompt data requests over a communications network to a plurality of prompt providers. In an embodiment, the prompt broadcast interface 108 is configured to broadcast the opportunity to provide prompt data to one or more content providers, specific artist group, peer group, etc. In an embodiment, the prompt broadcast interface 108 includes circuitry configured to broadcast the prompt request to a specific prompt provider based on classification data associated with the user-generated digital art content.

In an embodiment, the prompt broadcast interface 108 includes circuitry configured to broadcast the prompt request to a specific prompt provider based on a user selected interests or preference. In an embodiment, the prompt broadcast interface 108 is configured to classify received prompt data by creators and the system in order to be distributed based on preferences. In an embodiment, the prompt broadcast interface 108 is configured to rank received prompts based on user engagement frequency. In an embodiment, the prompt broadcast interface 108 includes a user engagement component configured to enable a social media engagement platform. In an embodiment, the prompt broadcast interface 108 is operably coupled to at least one virtual interface that enable users to engage via a social media engagement platform.

In an embodiment, the prompt broadcast interface 108 is operably coupled to at least one virtual interface that enable users to select icons indicative of a like. In an embodiment, the prompt broadcast interface 108 is operably coupled to at least one virtual interface that enable users to upload comments.

In an embodiment, the prompt broadcast interface 108 is configured to arrange user-generated digital art content based on a metric associated with a social media trend. In an embodiment, the prompt broadcast interface 108 is configured to arrange user-generated digital art content based on a metric associated with crowd-sourced comment data. In an embodiment, the prompt broadcast interface 108 is configured to receive participant generated prompt data from a plurality of users. In an embodiment, the prompt broadcast interface 108 is configured to exchange participant generated prompt data from a plurality of users, content providers, content creators, or authorized and authenticated users.

In an embodiment, the prompt broadcast interface 108 is configured to receive participant generated prompt data from a plurality of users; and wherein the digital art interface is configured to extract art element data from the participant generated prompt data.

In an embodiment, the digital art interface 102, the prompt determination component 106, the prompt output interface 110, the prompt broadcast interface 108, and the like includes electrical circuitry configured to enable remote communication, digital content exchange, and collaboration between multiple users in different physical locations are increasingly taking place in Shared Virtual Environments. See e.g., U.S. Pat. No. 11,100,561 (the contents of which are incorporated herein by reference in their entirety).

In an embodiment, the digital art system 100 includes one or more graphical user interface objects configured to respond to inputs directed toward the graphical user interface object. Examples of graphical user interface objects include, among other things, buttons, hyperlinks, icons, interface controls, selectable menu items, sliders, switches, and the like. See e.g., U.S. Pat. No. 11,327,648 (which content is incorporated herein by reference in full). See e.g., U.S. Pat. No. 11,327,648 (which content is incorporated herein by reference in full).

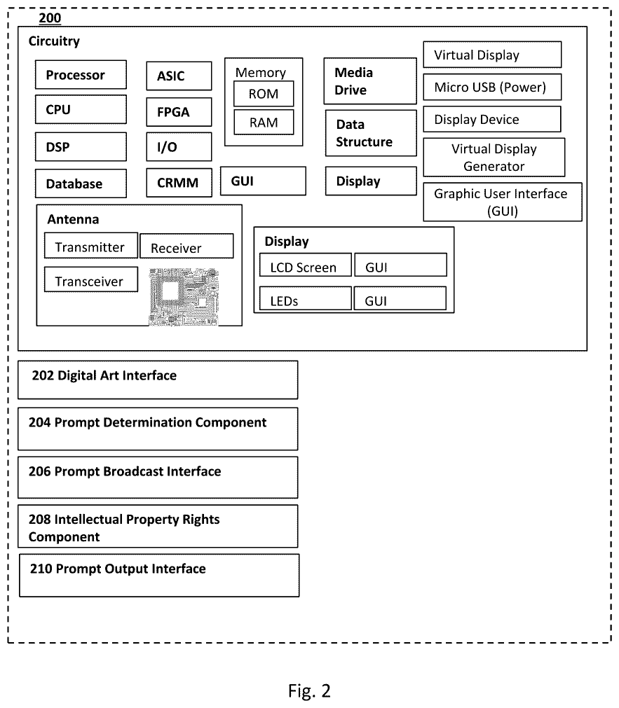

FIG. 2 shows a system 200 in which one or more of the disclosed methodologies or technologies can be implemented. In an embodiment, the system 200 includes a digital art interface 202 configured to receive user-generated digital art content and to extract art element data from the user-generated digital art content.

In an embodiment, the system 200 includes a prompt determination component 204 configured to determine prompt data based on the extracted art element data.

In an embodiment, the system 200 includes a prompt broadcast interface 206 configured to broadcast a prompt request based on receiving the user-generated digital art content.

In an embodiment, the system 200 includes an intellectual property rights component 208 configured to enable a blockchain smart contract process that implement a creative work license event associated with the user-generated digital art content or the prompt data. In an embodiment, the system 200 includes an intellectual property rights component 208 configured to enable creative commons license process associated with the user-generated digital art content or the prompt data.

Examples of Creative Commons licenses can be found at creativecommons.org/share-your-work/cclicenses/.

In an embodiment, the system 200 includes a prompt output interface 210 configured to generate one or more instances of a selectable menu that allows users to view the user-generated digital art content.

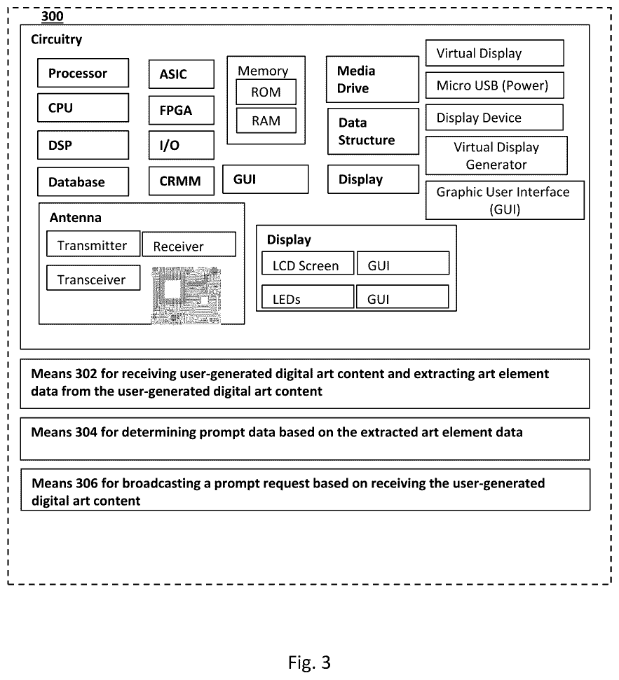

FIG. 3 shows a digital art prompt system 300 in which one or more of the disclosed methodologies or technologies can be implemented. In an embodiment, the system 300 includes means 302 for receiving user-generated digital art content and extracting art element data from the user-generated digital art content. In an embodiment, the system 300 includes means 304 for determining prompt data based on the extracted art element data. In an embodiment, the system 300 includes means 306 for broadcasting a prompt request based on receiving the user-generated digital art content. In an embodiment, the system 300 includes means 308 for exchanging prompt data between a plurality of users. In an embodiment, the system 300 includes means 310 for implementing a creative work license event associated with the user-generated digital art content or the prompt data.

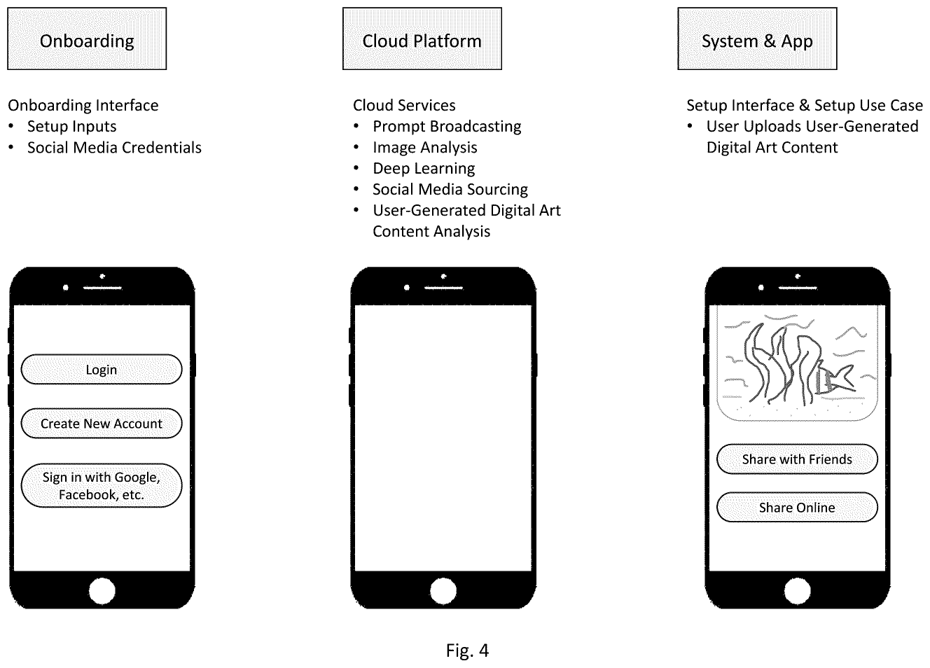

FIG. 4 shows an onboarding and user setup process.

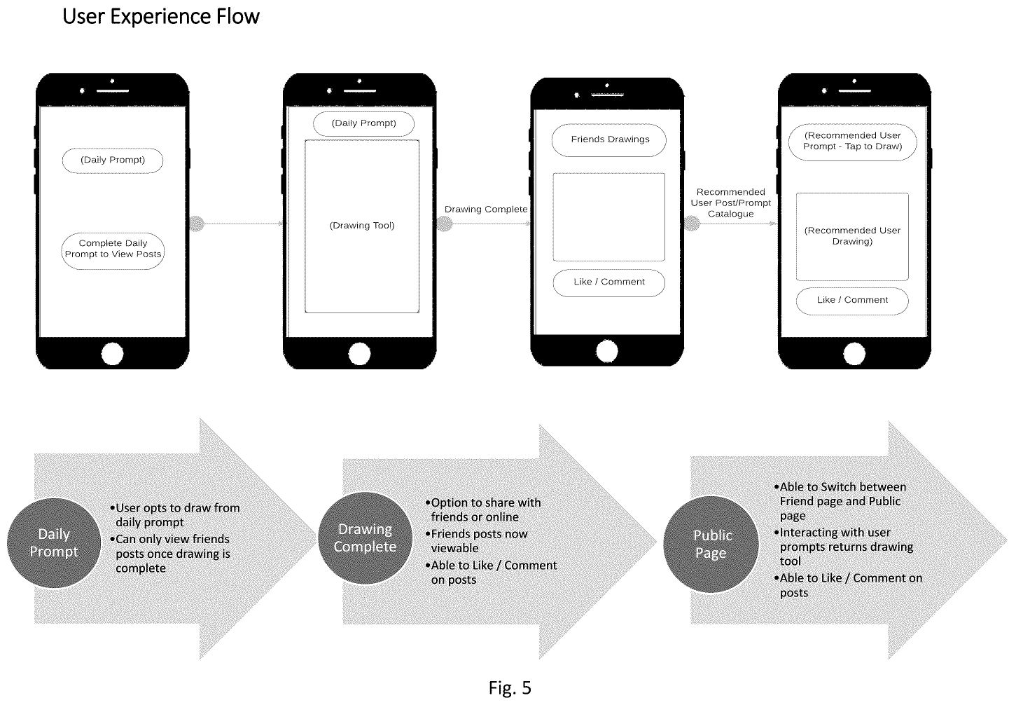

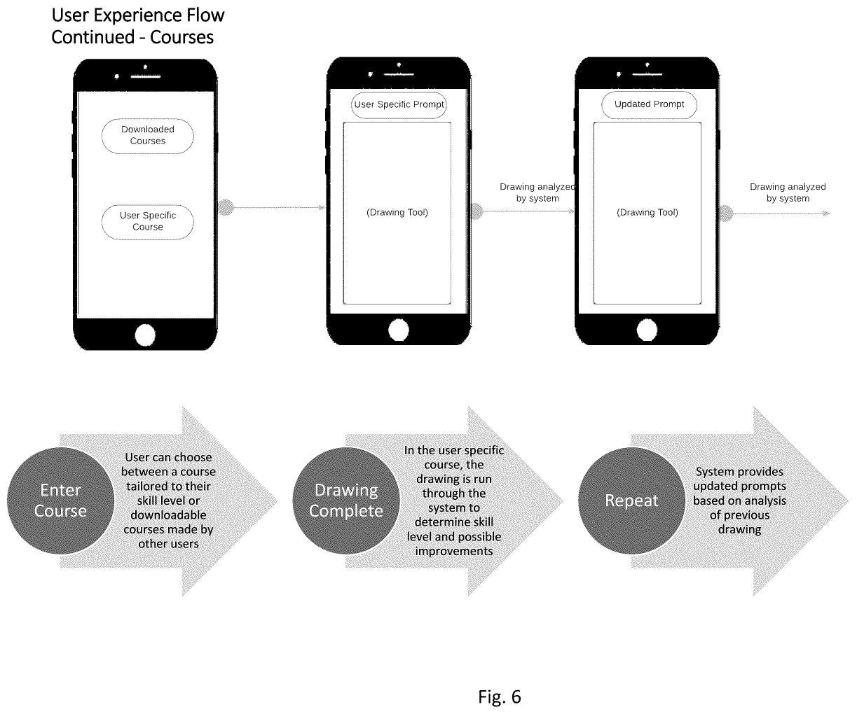

FIGS. 5&6 shows a user experience flow process for a digital art prompt system.

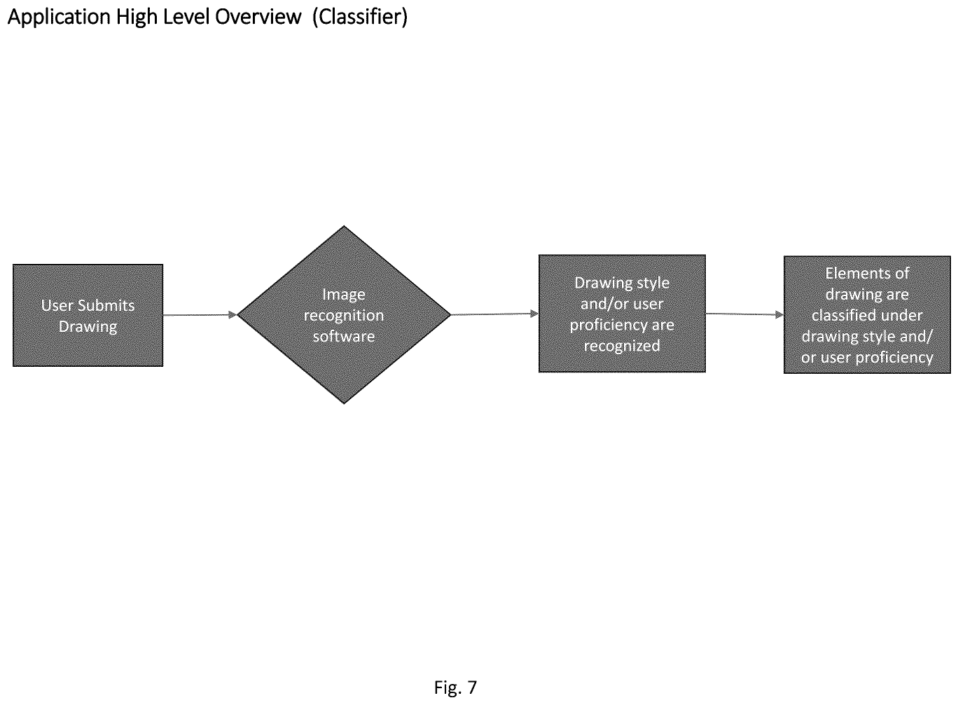

FIG. 7 shows an Application High Level Overview flow process for a digital art prompt system.

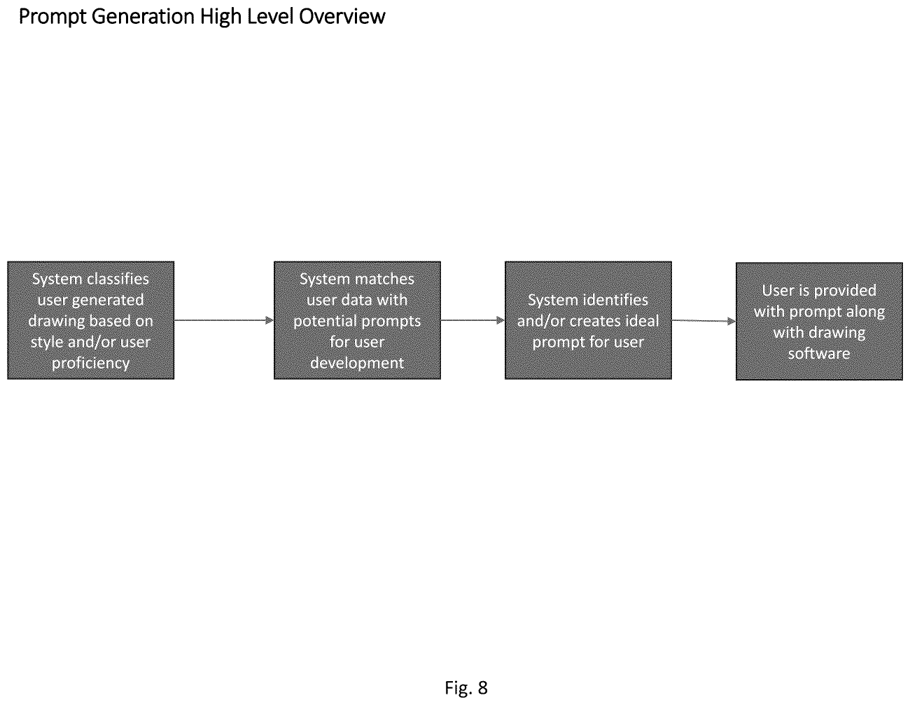

FIG. 8 shows Prompt Generation High Level Overview flow process for a digital art.

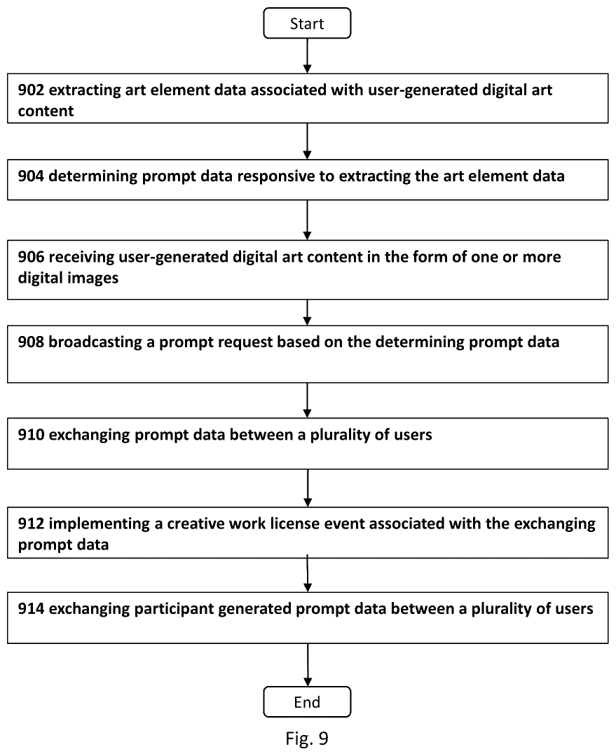

FIG. 9 shows a method 900 for implementing one or more technologies and methodologies.

At 902 the method 900 includes extracting art element data associated with user-generated digital art content. In an embodiment, extracting the art element data associated with user-generated digital art content includes determining a classification associated with the user-generated digital art content based on the extracted art element data. In an embodiment, extracting the art element data associated with user-generated digital art content includes extracting one or more parameters indicative of an art style. In an embodiment, extracting the art element data associated with user-generated digital art content includes extracting one or more parameters indicative of art media. In an embodiment, extracting the art element data associated with user-generated digital art content includes extracting one or more parameters indicative of a drawing style.

In an embodiment, extracting the art element data associated with user-generated digital art content includes causing an image recognition component 104 to extract art element data from the user-generated digital art content. In an embodiment, extracting the art element data associated with user-generated digital art content includes causing an image recognition component 104 to classify the user-generated digital art content. In an embodiment, extracting the art element data associated with user-generated digital art content includes causing an image recognition component 104 to detect objects within images associated with the user-generated digital art content.

In an embodiment, extracting the art element data associated with user-generated digital art content includes causing an image recognition component 104 to categorize pixels in an image associated with the user-generated digital art content into an art element class or art an element object (semantic image segmentation).

In an embodiment, extracting the art element data associated with user-generated digital art content includes extracting the art element data using one or more Artificial Neural Networks (ANN). In an embodiment, extracting the art element data associated with user-generated digital art content includes extracting the art element data using one or more Convolutional Neural Networks (CNN). In an embodiment, extracting the art element data associated with user-generated digital art content includes extracting the art element data using one or more Vision Transformers (ViT) using Natural Language Processing (NLP).

In an embodiment, extracting the art element data associated with user-generated digital art content includes extracting a metric associated with a social media trend; and arranging user-generated digital art content based on a metric associated with a social media trend. In an embodiment, extracting the art element data associated with user-generated digital art content includes a metric associated with crowd-sourced comment data; and automatically arranging user-generated digital art content based on a metric associated with crowd-sourced comment data.

At 904 the method 900 includes determining prompt data responsive to extracting the art element data. At 906 the method 900 includes receiving user-generated digital art content in the form of one or more digital images.

At 908 the method 900 includes broadcasting a prompt request based on the determining prompt data. In an embodiment, broadcasting the prompt request based on the determining prompt data includes transmitting prompt data requests over a communications network. In an embodiment, broadcasting the prompt request based on the determining prompt data includes transmitting prompt data requests to a unique prompt data provider. In an embodiment, broadcasting the prompt request based on the determining prompt data includes transmitting prompt data requests over a communications network to a plurality of prompt providers. In an embodiment, broadcasting the prompt request based on the determining prompt data includes broadcasting the opportunity to provide prompt data to one or more content providers, specific artist group, peer group, etc. In an embodiment, broadcasting the prompt request based on the determining prompt data includes broadcasting the prompt request to a specific prompt provider based on classification data associated with the user-generated digital art content. In an embodiment, wherein broadcasting the prompt request based on the determining prompt data includes broadcasting the prompt request to a specific prompt provider based on a user selected interests or preference. In an embodiment, broadcasting the prompt request based on the determining prompt data includes classifying received prompt data by creators and the system and broadcasting the prompt data distributed based on classification preferences. In an embodiment, broadcasting the prompt request based on the determining prompt data includes ranking received prompts based on user engagement frequency.

In an embodiment, broadcasting the prompt request based on the determining prompt data includes enabling a social media engagement platform. In an embodiment, broadcasting the prompt request based on the determining prompt data includes generating one or more instances in a virtual interface that enable users to engage via a social media engagement platform. In an embodiment, broadcasting the prompt request based on the determining prompt data includes generating one or more instances on a virtual interface that enable users to select icons indicative of a like. In an embodiment, broadcasting the prompt request based on the determining prompt data includes generating one or more instances on a virtual interface that enable users to upload comments. In an embodiment, broadcasting the prompt request based on the determining prompt data includes arranging user-generated digital art content based on a metric associated with a social media trend prior to broadcasting the prompt request.

In an embodiment, broadcasting the prompt request based on the determining prompt data includes automatically arranging user-generated digital art content based on a metric associated with crowd-sourced comment data. In an embodiment, broadcasting the prompt request based on the determining prompt data includes receiving participant generated prompt data from a plurality of users. In an embodiment, broadcasting the prompt request based on the determining prompt data includes exchanging participant generated prompt data from a plurality of users, content providers, content creators, or authorized and authenticated users.

At 910 the method 900 includes exchanging prompt data between a plurality of users. At 912 the method 900 includes implementing a creative work license event associated with the exchanging prompt data. At 914 the method 900 includes exchanging participant generated prompt data between a plurality of users.

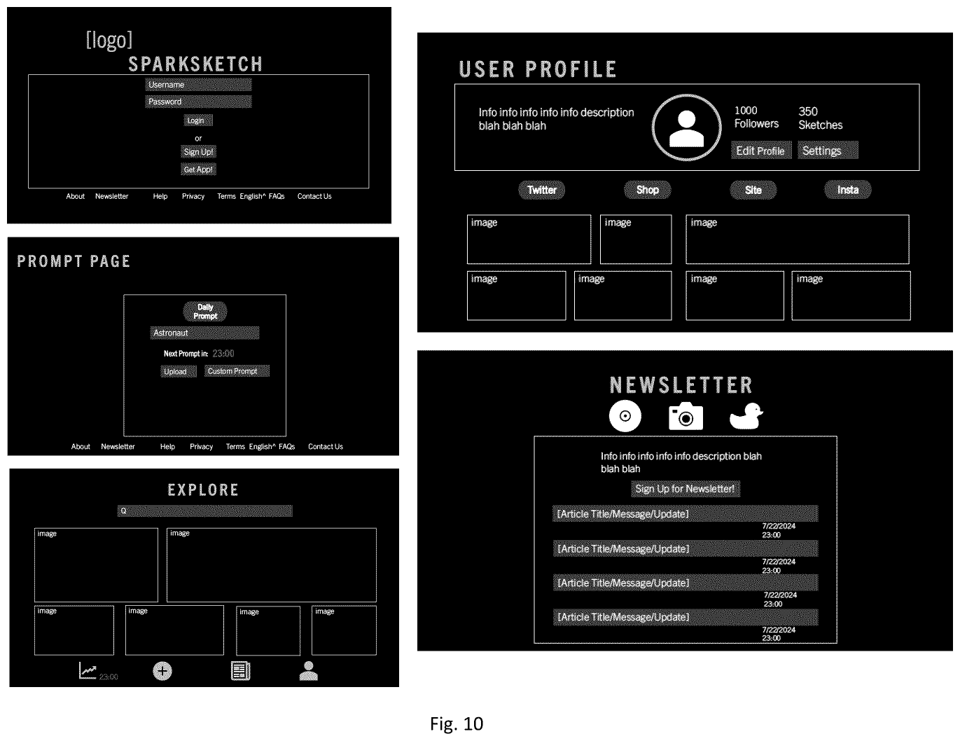

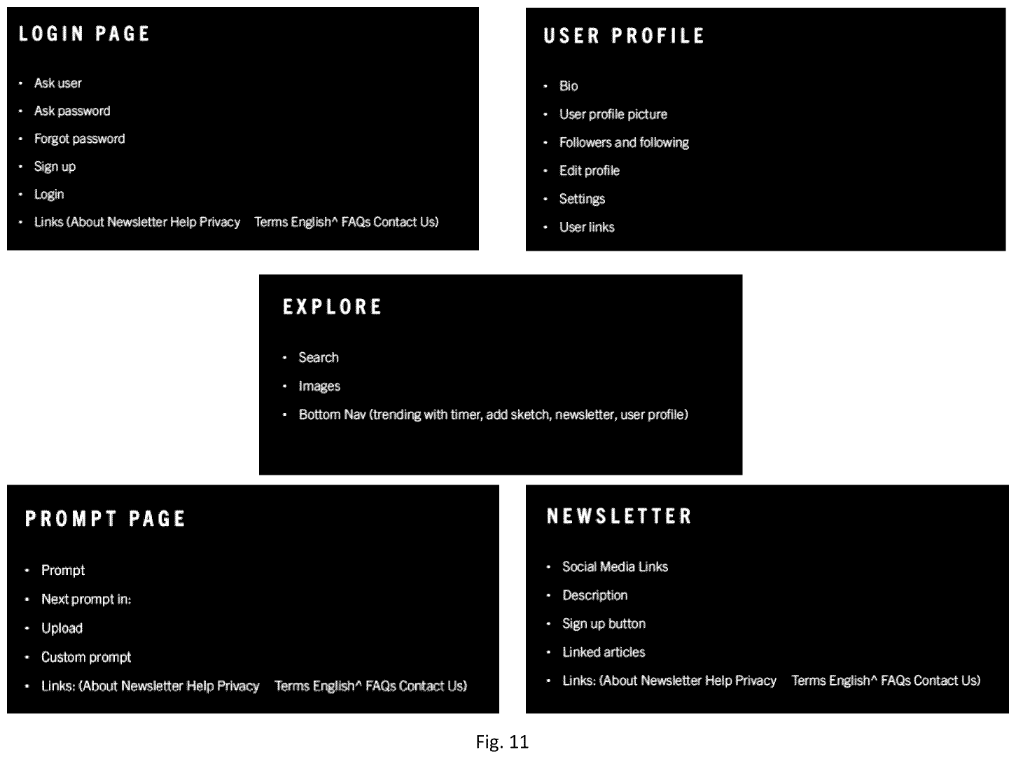

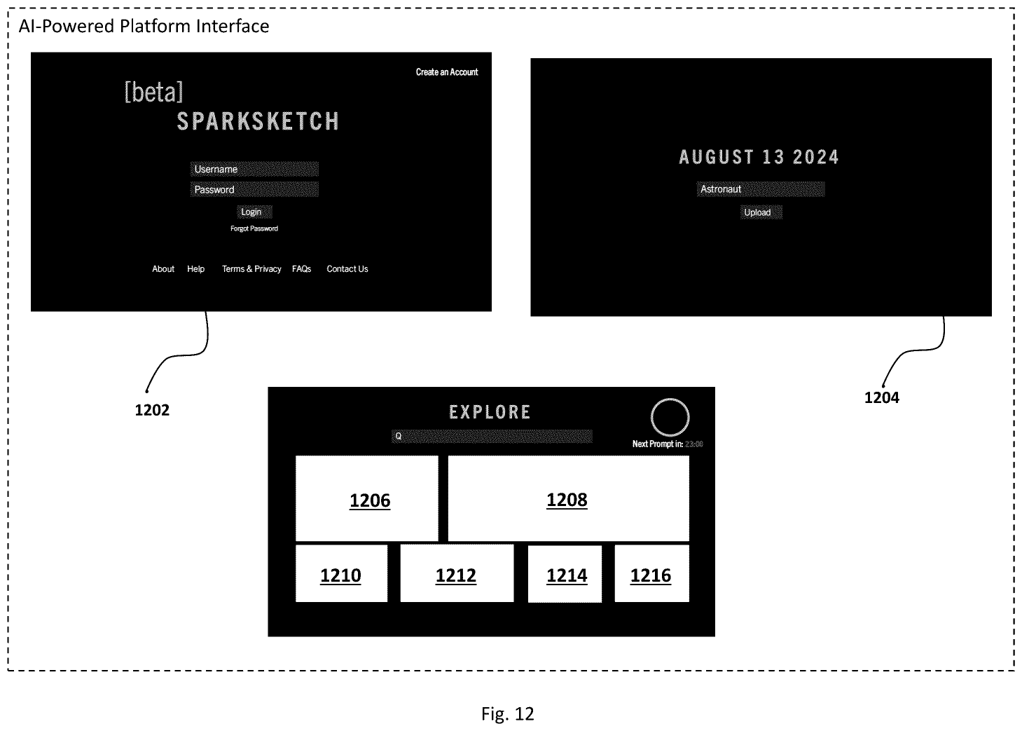

FIGS. 10-12 show an AI-powered platform interface implemented in computational circuitry configured to generate structured instructions configured to be interpreted and understood by a generative AI model. In an embodiment, the AI-powered platform interface includes computational circuitry configured to generate digital art prompts and structured instructions configured to be interpreted and understood by a generative AI model.

In an embodiment, the AI-powered platform interface includes an image recognition component configured to extract art element data from user-generated digital art content. In an embodiment, the AI-powered platform interface includes an image recognition component configured to classify the user-generated digital art content. In an embodiment, the AI-powered platform interface includes an image recognition component configured to detect objects within images associated with the user-generated digital art content.

In an embodiment, the AI-powered platform interface includes an image recognition component configured to categorize pixels in an image associated with the user-generated digital art content into an art element class or art an element object (semantic image segmentation). In an embodiment, the image recognition component 104 includes one or more Artificial Neural Networks (ANN) trained to extract art element data. In an embodiment, the image recognition component includes one or more Convolutional Neural Networks (CNN) trained to extract art element data. In an embodiment, the image recognition component 104 includes one or more Vision Transformers (ViT) using Natural Language Processing (NLP) trained to extract art element data.

In an embodiment, the AI-powered platform interface includes electrical circuitry and a user input interface 1202 configured to receive user-generated digital art content and to extract art element data from the user-generated digital art content. In an embodiment, the AI-powered platform interface includes electrical circuitry 1204 configured to determine prompt data based on the extracted art element data. In an embodiment, the AI-powered platform interface includes electrical circuitry configured to receive user-generated digital art content in the form of one or more digital images. In an embodiment, the AI-powered platform interface includes electrical circuitry configured to detect indicators of artist skill proficiency and to generate prompt data 1204, 1206, 1208, 1210, 1214, 1216, and the like responsive to one or more inputs indicative of artist skill proficiency level.

In a general sense, the various systems, devices, methods, technologies, methodologies, and the like described herein can be implemented by diverse types of electrical circuitry having a wide range of components, hardware, firmware, software, drivers, utilities, electrical components, electro-optical components, electro-mechanical components, and combination thereof, limited to patentable subject matter under 35 U.S.C. § 101.

Examples of electrical circuitry (e.g., computational circuitry, processing circuitry, control circuitry, and the like.) include application specific integrated circuits, discrete electrical circuits, integrated circuits, and the like.

In an embodiment, electrical circuitry includes, among other things, one or more computing devices such as a processor (e.g., a microprocessor), a central processing unit (CPU), a digital signal processor (DSP), an application-specific integrated circuit (ASIC), a field programmable gate array (FPGA), or the like, or any combinations thereof, and can include discrete digital or analog circuit elements or electronics, or combinations thereof. In an embodiment, electrical circuitry includes one or more ASICs having a plurality of predefined logic components. In an embodiment, electrical circuitry includes one or more FPGA having a plurality of programmable logic components.

In an embodiment, electrical circuitry includes one or more electrical components operably coupled (e.g., communicatively, electromagnetically, magnetically, ultrasonically, optically inductively, electrically, capacitively coupled, and the like) to each other. In an embodiment, electrical circuitry includes one or more remotely located components. In an embodiment, remotely located components are operably coupled via wireless communication. In an embodiment, remotely located components are operably coupled via one or more receivers, transceivers, or transmitters, antennas, or the like.

In an embodiment, electrical circuitry includes one or more network elements. Non-limiting examples of network elements include Local Area Networks (LANs), network gateway systems, network usage servers, Wide Area Networks (WANs), wireless base stations, wireless relays, and the like. In an embodiment, electrical circuitry includes computer and communication platforms that include data Input/Output (I/O) transceivers, digital processing circuitry, data storage memories, various software components, and the like.

In an embodiment, electrical circuitry includes one or more memory devices that, for example, store instructions or data for example, in an embodiment, the system 100 includes one or more memory devices storing user-specific sustainability information, user-specific carbon footprint information, enterprise-wide sustainability information, or enterprise-wide carbon footprint information with a remote client device and remote server. Non-limiting examples of one or more memory devices include volatile memory (e.g., Random Access Memory (RAM), Dynamic Random-Access Memory (DRAM), or the like); non-volatile memory (e.g., Read-Only Memory (RUM), Electrically Erasable Programmable Read-Only Memory (EEPROM), Flash memory, or the like); persistent memory; or the like. The one or more memory device can be coupled to, for example, one or more computing devices by one or more instructions, data, or power buses.

In an embodiment, electrical circuitry includes one or more computer-readable media drives, interface sockets, Universal Serial Bus (USB) ports, memory card slots, or the like, and one or more input/output components such as, for example, a graphical user interface, a display, a keyboard, a keypad, a trackball, a joystick, a touchscreen, a touch-sensitive display, a mouse, a switch, a dial, or the like, and any other peripheral device. In an embodiment, electrical circuitry includes one or more user input/output components that are operably coupled to at least one computing device to control (electrical, electromechanical, software-implemented, firmware-implemented, or other control, or combinations thereof) at least one parameter associated with, for example, generating a user interface presenting a rating menu and receive one or more inputs indicative of a rating associated with the event based on the rating menu.

In an embodiment, electrical circuitry includes a computer-readable media drive or memory slot that is configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as a magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., receiver, transceiver, or transmitter, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

In an embodiment, electrical circuitry includes computing circuitry, memory circuitry, electrical circuitry, electro-mechanical circuitry, control circuitry, transceiver circuitry, transmitter circuitry, receiver circuitry, and the like. For example, in an embodiment, the digital art interface 102, the prompt determination component 106, the prompt output interface 110, the prompt broadcast interface 108, and the like comprises one or more of computing device circuitry, memory circuitry, and at least one of transceiver circuitry, transmitter circuitry, and receiver circuitry.

The herein described subject matter sometimes illustrates different components contained within, or connected with, different other components. It is to be understood that such depicted architectures are merely examples, and that in fact, a multitude of other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include, but are not limited to, physically mateable, physically interacting components, wirelessly interactable, wirelessly interacting components, logically interacting, logically interactable components, etc.

In an embodiment, one or more components may be referred to herein as “configured to,” “configurable to,” “operable/operative to,” “adapted/adaptable,” “able to,” “conformable/conformed to,” etc. Such terms (e.g., “configured to”) can encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and or firmware would be well within the skill of one of skill in the art in light of this disclosure. In addition, the mechanisms of the subject matter described herein are capable of being distributed as a program product in a variety of forms, and that an illustrative embodiment of the subject matter described herein applies regardless of the type of signal-bearing medium used to conduct the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link (e.g., transmitter, receiver, transmission logic, reception logic, etc.), etc.).

While aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and B together, A and C together, B and C together, and/or A, B, and C together, etc.). Typically, a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), the various operations may be performed in orders other than those that are illustrated or may be performed concurrently. Examples of such alternate orderings includes overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are not intended to exclude such variants, unless context dictates otherwise.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A digital art system, comprising:
a digital art interface including electrical circuitry configured to receive user-generated digital art content and to extract art element data from the user-generated digital art content; and
a prompt determination component including electrical circuitry configured to determine prompt data based on the extracted art element data and to generate prompt data responsive to one or more inputs indicative of artist skill proficiency level.

2. The digital art system of claim 1, wherein the digital art interface includes an image recognition component trained to recognize artist skill proficiency indicators within the user-generated digital art content and to generate the prompt data responsive to the one or more inputs indicative of artist skill proficiency level.

3. The digital art system of claim 1, wherein the digital art interface includes an image recognition component configured to categorize pixels in an image associated with the user-generated digital art content into an art element class or art an element object; wherein the image recognition component includes one or more Artificial Neural Networks (ANN) trained to extract art element data, Convolutional Neural Networks (CNN) trained to extract art element data, or Vision Transformers (ViT) using Natural Language Processing (NLP) trained to extract art element data.

4. The digital art generation system of claim 1, wherein the prompt determination component is configured to determine the prompt data based on one or more inputs indicative of a social media trend.

5. The digital art generation system of claim 1, wherein the prompt determination component is configured to determine the prompt data based on crowd-sourced data.

6. The digital art generation system of claim 1, wherein the digital art interface is configured to determine a classification associated with the user-generated digital art content; and the prompt determination component is configured to determine the prompt data based on the classification associated with the user-generated digital art content.

7. The digital art generation system of claim 1, wherein the prompt determination component is configured to generate digital art prompts and structured instructions configured to be interpreted and understood by a generative AI model data responsive to the one or more inputs indicative of artist skill proficiency level.

8. The digital art generation system of claim 1, wherein the prompt determination component includes an artificial intelligence module trained to detect indicators of artist skill proficiency and to determine and store in memory a user prompt ability profile based on the extracted art element data, and a correlation policy.

9. The digital art system of claim 1, further comprising
a prompt broadcast interface including electrical circuitry configured to broadcast a prompt request based on receiving the user-generated digital art content.

10. The digital art generation system of claim 1, further comprising:
a prompt output interface;
wherein the prompt output includes one or more instances of a selectable menu that allows users to view the user-generated digital art content.

11. A system, comprising:
a digital art interface configured to receive user-generated digital art content and to extract art element data from the user-generated digital art content;
a prompt determination component configured to determine prompt data based on the extracted art element data; and
a prompt broadcast interface configured to broadcast a prompt request based on receiving the user-generated digital art content.

12. The system of claim 11, further comprising:
an intellectual property rights component configured to enable a blockchain smart contract process that implement a creative work license event associated with the user-generated digital art content or the prompt data.

13. The system of claim 11, further comprising:
a prompt output interface configured to generate one or more instances of a selectable menu that allows users to view the user-generated digital art content.

14. A method, comprising:
extracting art element data associated with user-generated digital art content; and
determining prompt data responsive to extracting the art element data.

15. The method of claim 14, wherein extracting the art element data associated with user-generated digital art content includes determining a classification associated with the user-generated digital art content based on the extracted art element data.

16. The method of claim 14, further comprising:
receiving user-generated digital art content in the form of one or more digital images.

17. The method of claim 14, further comprising:
broadcasting a prompt request based on the determining prompt data; wherein broadcasting the prompt request based on the determining prompt data includes transmitting prompt data requests over a communications network.

18. The method of claim 14, further comprising:
exchanging prompt data between a plurality of users.

19. The method of claim 14, further comprising:
implementing a creative work license event associated with the exchanging prompt data.

20. The method of claim 14, further comprising:
exchanging participant generated prompt data between a plurality of users.
